(19) United States
(12) Patent Application Publication
(10) Pub. No.: US 2024/0400277 A1
(43) Pub. Date: Dec. 5, 2024

(54) PACKAGING PIECE FOR PHOTOVOLTAIC MODULE PACKAGING

(71) Applicant: Maxeon Solar Pte. Ltd., Singapore (SG)

(72) Inventors: Jianxun Wu, Hubei Province (CN); Yafu Lin, Pleasanton, CA (US); Yonggang Guo, Baoding (CN)

(21) Appl. No.: 18/203,659

(22) Filed: May 31, 2023

(51) Int. Cl. B65D 61/00; B65D 71/00; B65D 85/48

(52) U.S. Cl. CPC B65D 61/00; B65D 71/0092; B65D 85/48

(57) ABSTRACT

A packaging piece is disclosed. The packaging piece includes a first side that includes a first module frame interlocking structure configured to snap fit to a drainage hole of a module frame in a first orientation and to extend toward a glass surface of a module in a second orientation. The packaging piece also includes a second side that includes: a second module frame interlocking structure configured to extend toward the glass surface of the module in the first orientation and to snap fit to the drainage hole of the module frame in the second orientation.

### TECHNICAL FIELD

Embodiments of the disclosure pertain to packaging pieces for photovoltaic modules, and more particularly, to interlockable packaging pieces for use in photovoltaic module packaging.

### BACKGROUND

Conventional packaging piece design makes use of the flange of frames of photovoltaic modules to facilitate the attachment of packaging pieces to photovoltaic modules (to facilitate the firm engagement of the packaging pieces to the module). This design is dependent on both long frame flange and short frame flange dimensions. Thus, the packaging pieces cannot be used with modules with frame flanges whose dimensions are different from the dimensions of the frame flanges for which they are designed. Because of this, the application and extension usage of such packaging pieces are limited. In addition, because each frame only has a single flange, the packaging pieces can only be used in an orientation that facilitates attachment to that flange. This limits the stacking of modules to stacking arrangements where individual modules are positioned in the stack of modules with the same orientation. Thus, if the package is to be packed using back-to-back and face-to-face module orientations, such packaging pieces cannot be used.

### BRIEF DESCRIPTION OF THE DRAWINGS

FIG. 1A shows the components of an exemplary packaging piece according to one embodiment.

FIG. 1B shows a top view of a packaging piece that illustrates packaging piece interlocking structures according to one embodiment.

FIG. 1C shows a bottom view of a packaging piece that illustrates packaging piece interlocking cavities according to one embodiment.

FIG. 1D shows a view of a packaging piece that illustrates features of the space between sidewalls of the packaging piece and packaging piece interlocking structures.

FIG. 1E shows a view of a packaging piece from a backside of a packaging piece according to one embodiment.

FIG. 1F shows a module that includes a frontside, backside, and frame according to one embodiment.

FIG. 1G shows a cross section of a photovoltaic module according to one embodiment.

FIG. 1H shows a cross section of a portion of a photovoltaic module and packaging piece when the packaging piece is attached to the corner of the photovoltaic module according to one embodiment.

FIG. 1I shows a cross section of a portion of a photovoltaic module and packaging piece when the packaging piece is attached to the corner of the photovoltaic module according to one embodiment.

FIG. 1J shows a stack of modules stacked using a backside to frontside stacking arrangement according to one embodiment.

FIG. 1K shows how packaging pieces are oriented when the modules to which they are attached are stacked using a backside to frontside stacking arrangement according to one embodiment.

FIG. 1L shows a short side perspective of a photovoltaic module stack that uses an alternating sunny side up and sunny side down arrangement of modules according to one embodiment.

FIG. 1M shows a long side perspective of a photovoltaic module stack that uses an alternating sunny side up and sunny side down arrangement of modules according to one embodiment.

FIG. 1N is an exploded view of an alternating sunny side up and sunny side down arrangement of modules that shows relative positions of the modules and their alternating current microinverter (ACMI) according to one embodiment.

FIG. 1O shows how packaging pieces are oriented when the modules to which they are attached are stacked using an alternating arrangement of modules according to one embodiment.

FIG. 2 shows a flowchart of a method of forming a packaging piece according to one embodiment.

### DESCRIPTION OF THE EMBODIMENTS

In the following description, numerous specific details are set forth, in order to provide a thorough understanding of embodiments of the present disclosure. It will be apparent to one skilled in the art that embodiments of the present disclosure may be practiced without these specific details. In other instances, well-known features, are not described in detail in order to not unnecessarily obscure embodiments of the present disclosure. Furthermore, it is to be appreciated that the various embodiments shown in the Figures are illustrative representations and are not necessarily drawn to scale.

Certain terminology may also be used in the following description for the purpose of reference only, and thus is not intended to be limiting. For example, terms such as “upper”, “lower”, “above”, and “below” refer to directions in the drawings to which reference is made. Terms such as “top”, “center,” “front”, “back”, “rear”, and “side” describe the orientation and/or location of portions of the component within a consistent but arbitrary frame of reference which is made clear by reference to the text and the associated drawings describing the component under discussion. Such terminology may include the words specifically mentioned above, derivatives thereof, and words of similar import.

As used herein the term “package” is intended to refer to one or more modules that are bundled and/or boxed for storage or transit.

As used herein the term “packaging” is intended to refer to the act of creating a package of modules.

As used herein, the term “pack” is intended to refer to one or more vertically or horizontally placed modules. A pack of one module would include a single module vertically or horizontally disposed. A pack of two or more modules would comprise two or more either vertically or horizontally disposed modules for packaging.

As used herein the term “packing,” or, to “pack” is intended to refer to the act of placing one or more modules either vertically or horizontally together for packaging.

As used herein, the term “stack” is intended to refer to a pile of horizontally oriented modules that can be used in the preparation of a package. As used herein to “stack” is intended to refer to the act of piling a plurality of horizontally oriented modules for use in the preparation of a package.

As used herein the term “full pallet package” of modules is intended to refer to a package of modules that contains the number of modules that is considered to completely fill the package of modules.

As used herein the term “partial pallet package” of modules is intended to refer to a package of modules that contains a number of modules that is less than that which is considered to completely fill the package of modules.

As used herein the term “packaging piece” is intended to refer to a device that can be firmly fastened or clipped to the frame of a photovoltaic module and which is interlockable with other packaging pieces.

In one embodiment, a packaging piece can include but is not limited to corner pieces that can be attached to the corners of a “solar panel” or “photvolataic module”.

As used herein the term “clip piece” or “module clip piece” is intended to refer to

a packaging piece.

As used herein the term “solar panel” or “photvolataic module” is intended to refer to is an assembly of photovoltaic solar cells mounted in a (usually rectangular) frame.

As used herein the term “module” is intended to refer to a solar panel or a photovoltaic module.

As used herein the term “face” or “front” or “frontside” is intended to refer to the side of a solar panel or photovoltaic module that is configured to be directed toward radiation.

As used herein the term “back” or “backside” is intended to refer to the side of a solar panel or photovoltaic module that is opposite the “front” or “frontside”.

As used herein the term “alternating module stacking arrangement” is intended to refer to modules that are stacked such that adjacent modules in a stack of modules have their front sides and backsides oriented in opposite directions. In one embodiment, an alternating module stacking arrangement results in face-to-face and/or back-to-back module orientations. Moreover, in one embodiment, in an alternating module stacking arrangement, the ends of the adjacent modules in the stack of modules can be oriented in opposite directions.

As used herein the term “non-alternating module stacking arrangement” is intended to refer to modules that are stacked such that adjacent modules in a stack of modules have their front sides and backsides oriented in the same directions.

As used herein the term “package” is intended to refer to one or more modules that are bundled and/or boxed for storage or transit.

As used herein the term “packaging” is intended to refer to the act of creating a package of modules.

As used herein, the term “pack” is intended to refer to one or more vertically or horizontally placed modules. A pack of one module would include a single module vertically or horizontally disposed. A pack of two or more modules would comprise two or more either vertically or horizontally disposed modules for packaging.

As used herein the term “packing,” or, to “pack” is intended to refer to the act of placing one or more modules either vertically or horizontally together for packaging.

As used herein, the term “stack” is intended to refer to a pile of horizontally oriented modules that can be used in the preparation of a package. As used herein to “stack” is intended to refer to the act of piling a plurality of horizontally oriented modules for use in the preparation of a package.

As used herein, a reference number associated with a component of a packaging piece that includes a lower-case letter is intended to refer to a specific feature of the packaging piece. For example, the reference number 100i, as used herein, is intended to refer to a frame interlocking structure of a packaging piece. As used herein, where a reference number is associated with a photovoltaic module and includes a subscript, the subscript is intended to refer to a specific place at which the photovoltaic module is located in a stack of modules 1-n. For example, 1011 is intended to refer to the photovoltaic module 1 in a stack of n modules. As used herein, where a reference number is associated with a packaging piece and includes a subscript, the subscript is intended to refer to a specific photovoltaic module in a stack of photovoltaic modules that are numbered 1-n. For example, 100ₗ is intended to refer to a packaging piece that is attached to the first photovoltaic module “1” in a stack of “n” photovoltaic modules.

Conventional packaging piece design makes use of the flange of frames of photovoltaic modules to facilitate the attachment of packaging pieces to photovoltaic modules (to facilitate the firm engagement of the packaging pieces to the module). This design is dependent on both long frame flange and short frame flange dimensions. Thus, the packaging pieces cannot be used with modules with frame flanges whose dimensions are different from the dimensions of the frame flanges for which they are designed. Because of this, the application and extension usage of such packaging pieces are limited. In addition, because each frame only has a single flange, the packaging pieces can only be used in an orientation that facilitates attachment to that flange. This limits the stacking of modules to stacking arrangements where individual modules are positioned in the stack of modules with the same orientation. Thus, if the package is to be packed using alternating module orientations (e.g., packed using back-to-back and face-to-face module orientations), such packaging pieces cannot be used.

Approaches that overcome the challenges of such previous approaches are disclosed herein. As part of a disclosed embodiment, a packaging piece is disclosed. The packaging piece includes a first side that includes: a first module frame interlocking structure configured to snap fit to a drainage hole of a module frame in a first orientation and to extend toward a glass surface of a module in a second orientation; and a second side that includes: a second module frame interlocking structure configured to extend toward the glass surface of the module in the first orientation and to snap fit to the drainage hole of the module frame in the second orientation. In one embodiment, the packaging piece is able to be snap fitted to the drainage hole of most types of modules. In addition, because the packaging piece is able to be snap fitted to drainage holes in both first and second orientations, the packaging piece enables a packing of modules in two orientations: a single direction or a “back-to-back, face to face” orientation.

In one embodiment, packaging pieces can make the packaging of partial pallet packages more convenient and can help protect modules from damage during transport. For example, for vertically packed packages, packaging pieces can make the packaging of partial pallet packages convenient by eliminating the need to apply rigid support structures to modules before they are turned upright in a vertically oriented direction. In one embodiment, the rigid support structures are made unnecessary by packaging piece interlocking structures that firmly interlock the modules to which packaging pieces are attached together. Modules interlocked in this manner form a rigid structure that unlike modules stacked using conventional partial pallet preparation processes, are prevented from falling apart before they are strapped. For horizontal partial pallet packages, packaging is made more convenient as multiple modules of a partial pallet package can be simultaneously aligned to provide a neat and agreeable package appearance (because packaging piece interlocking structures are configured to readily fit into the packaging piece interlocking cavities of the packaging pieces attached to adjacent modules).

Packaging pieces protect horizontal partial pallet packages, by transferring shocks and vibrations encountered during their transport to their pallets and away from their modules (to prevent micro-cracks). Because of such protection, the maximum quantity of modules that can be included in a horizontal partial pallet package can be increased by up to 21 modules. For vertical partial pallet packages, because packaging pieces limit a module's movement within the space between their sidewalls, modules are prevented from swaying and/or otherwise moving. In this manner, frame scratches between adjacent modules are avoided. Furthermore, the interlocking structures, hold the interlocked modules together, such that they are prevented from falling apart, even when straps loosen during their transport (which eliminates a critical safety concern).

### Packaging Piece for Module Packaging

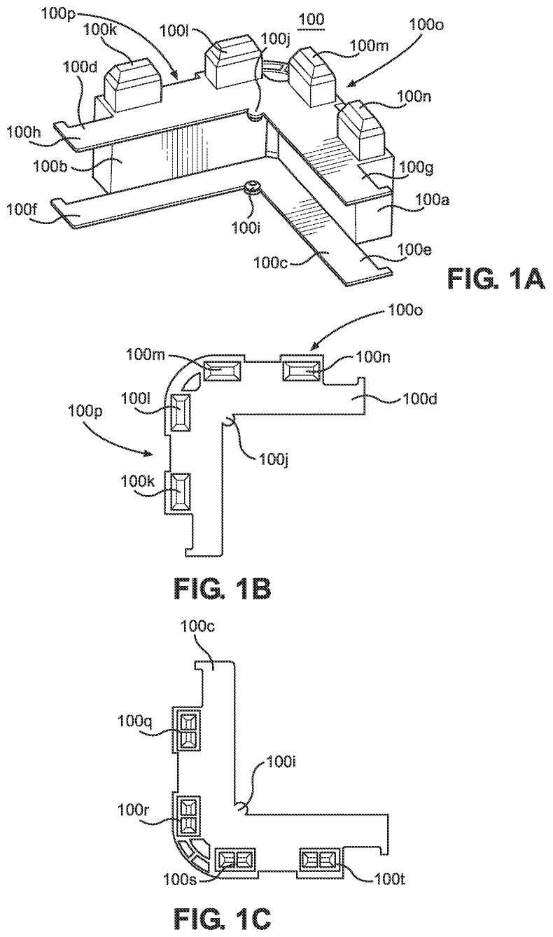

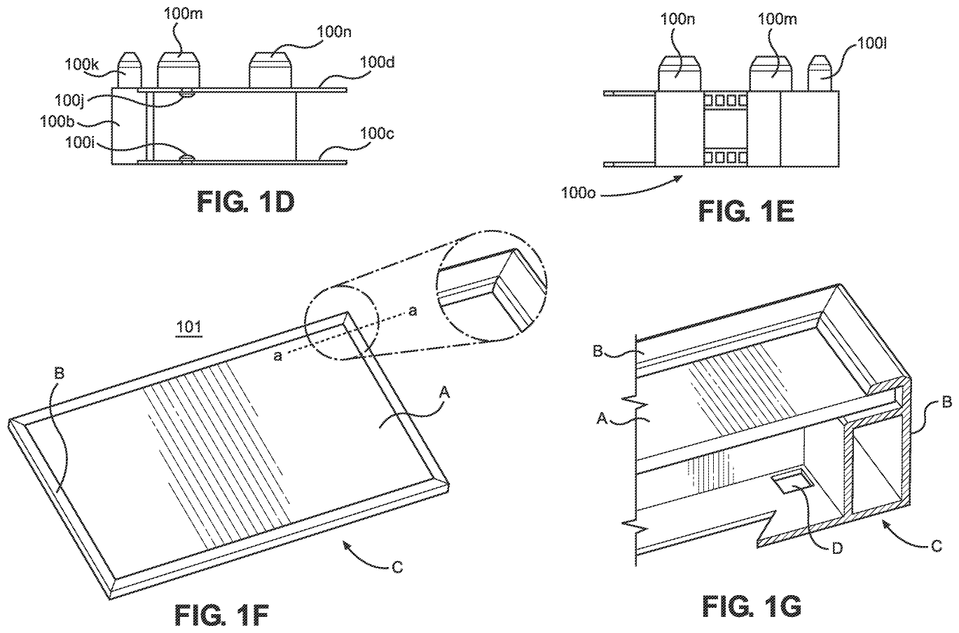

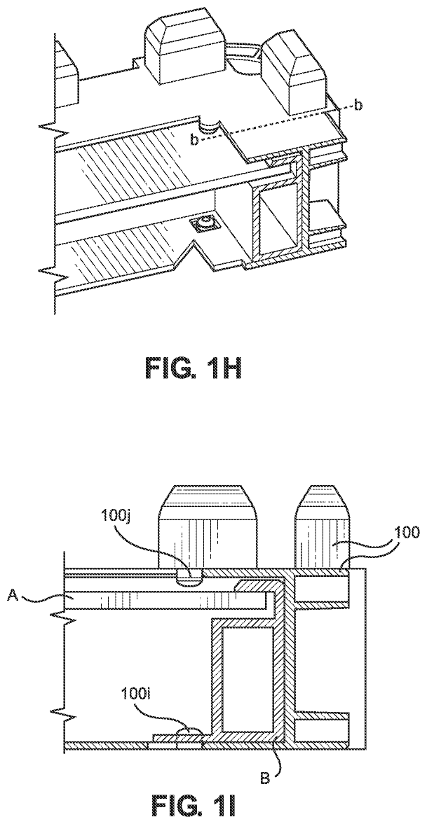

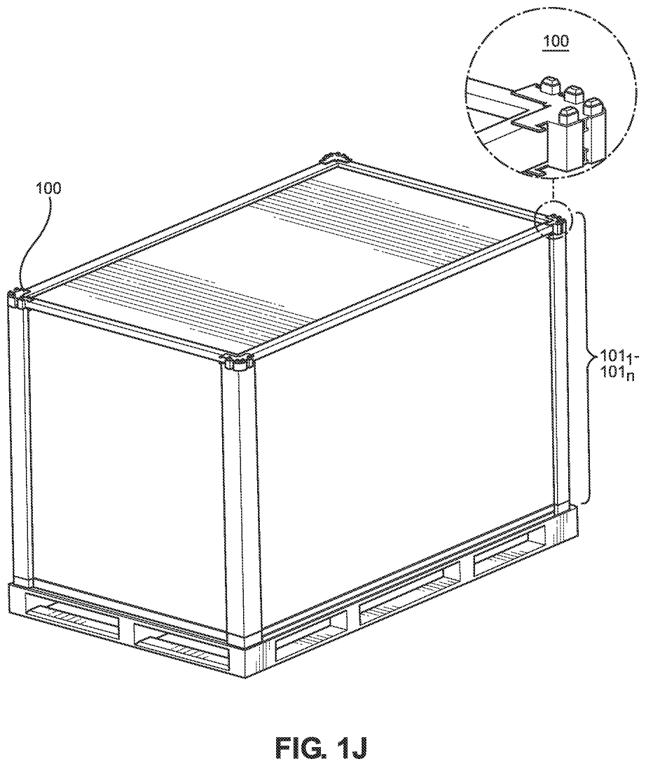

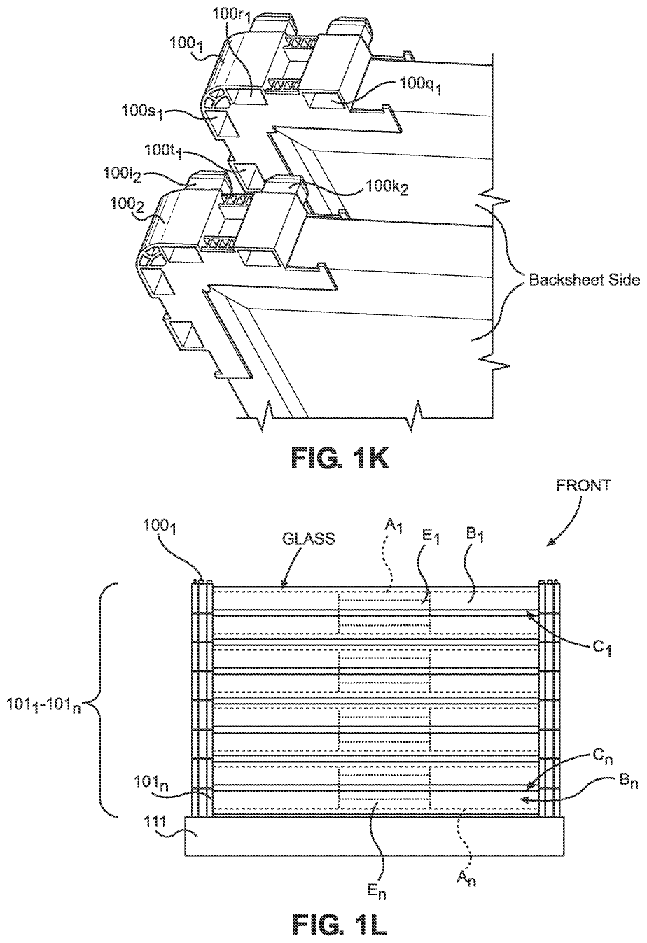

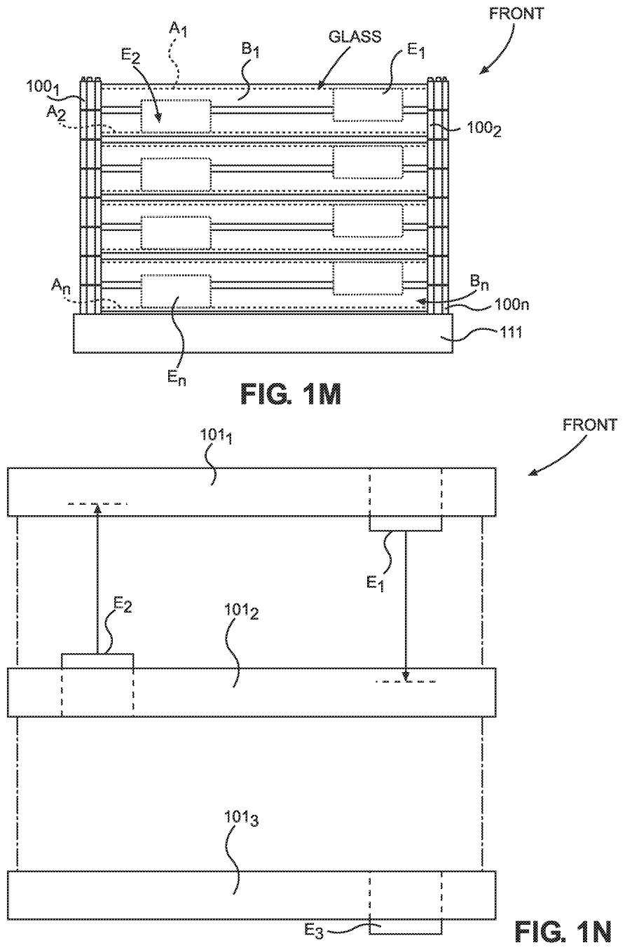

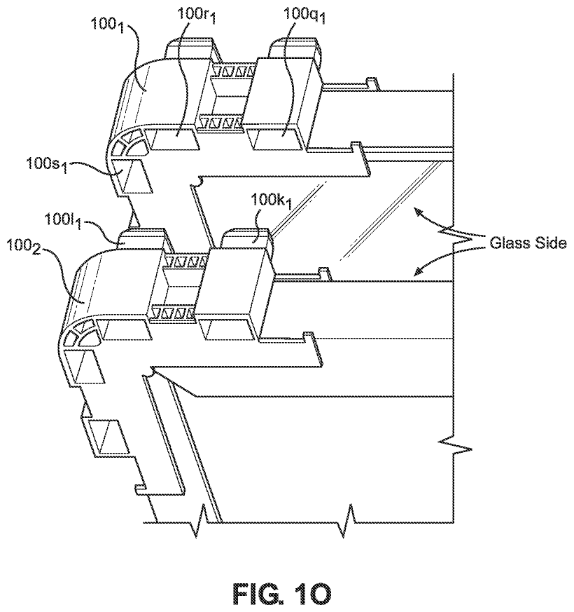

FIG. 1A shows the components of an exemplary packaging piece 100 according to one embodiment. In one embodiment, the exemplary packaging piece 100 is a module clip piece that can be attached to the corners of a photovoltaic module and used for packaging and shipping purposes. Referring to FIG. 1A, in one embodiment, the packaging piece 100 includes, orthogonal first L-angle portion 100a and second L-angle portion 100b (that together form an L shaped profile), and first sidewall structure 100c and second sidewall structure 100d that extend between respective sides of the first L-angle portion 100a and the second L-angle portion 100b.

In one embodiment, the first sidewall structure 100c has an L-shaped perimeter profile. In one embodiment, the L-shaped perimeter profile of the first sidewall structure 100cincludes a first orthogonally oriented portion 100e and a second orthogonally oriented portion 100f. Likewise, in one embodiment, the second sidewall structure 100d has an L-shaped perimeter profile. In one embodiment, the second sidewall structure 100d includes a first orthogonally oriented portion 100g and a second orthogonally oriented portion 100h.

In one embodiment, the first sidewall structure 100c includes a first frame interlocking structure 100i that is formed at the intersection of the first orthogonally oriented portion 100e and the second orthogonally oriented portion 100f of the first sidewall structure 100c. In one embodiment, the first frame interlocking structure 100i extends in a direction that is perpendicular to the inner surface of the first sidewall structure 100c.

In one embodiment, the second sidewall structure 100d includes a second frame interlocking structure 100j that is formed at the intersection of the first orthogonally oriented portion 100g and the second orthogonally oriented portion 100h of the second sidewall structure 100d. In one embodiment, the second frame interlocking structure 100j extends in a direction that is perpendicular to the inner surface of the second sidewall structure 100d.

In one embodiment, the first frame interlocking structure 100i and the second frame interlocking structure 100j can include a shaft portion and a head portion. However, in one embodiment, the first frame interlocking structure 100i and the second frame interlocking structure 100j can have any shape, that is suitable to facilitate the herein described interlock of the first frame interlocking structure 100i or the second frame interlocking structure 100j and a drainage hole of a module frame flange as is described herein.

FIGS. 1B-1E show various views of the packaging piece 100 shown in FIG. 1A. FIG. 1B shows a top view of the packaging piece 100 that illustrates the packaging piece interlocking structures 100k, 100l, 100m and 100n and the module frame interlocking structure 100j (as viewed from the outside surface of the second sidewall 100d). FIG. 1C shows a bottom view of the packaging piece 100 that illustrates the packaging piece interlocking cavities 100q, 100r, 100s and 100t and the module frame interlocking structure 100i (as viewed from the outside surface of the first sidewall 100c). FIG. 1D shows a view of the packaging piece 100 that illustrates features of the space between sidewalls 100c and 100d, and the packaging piece interlocking structures 100k, 100m and 100n, and provides a perspective view of the second L-angle portion 100b of the packaging piece 100. FIG. 1D also shows a perspective view of first module frame interlocking structure 100i and second module frame interlocking structure 100j. FIG. 1E shows a view of the packaging piece 100 from the back side 100o of the packaging piece 100. In addition to showing features of the backside 1000 of the packaging piece 100, FIG. 1E also shows the packaging piece interlocking structures 100l, 100m and 100n.

FIG. 1F shows a photovoltaic module 101 according to one embodiment. In one embodiment, the photovoltaic module 101 includes front side A, frame B, and back side C. In one embodiment, the front side A includes the glass component of the photovoltaic module 101. FIG. 1G shows a cross section of the photovoltaic module 101 through a-a shown in FIG. 1F. In addition to front side A, frame B, and back side C, FIG. 1G shows drainage hole D. In one embodiment, a packaging piece 100 can be attached to each corner of the photovoltaic module 101. FIG. 1H shows a cross section of a portion of the photovoltaic module 101 and the packaging piece 100 through a-a when the packaging piece 100 is attached to the corner of the photovoltaic module 101. Referring to FIGS. 1A-1H, when the packaging piece 100 is placed onto a corner of the photovoltaic module 101 and pushed forward to fully engage the frame B of the photovoltaic module 101, the frame interlocking structure 100i of the packaging piece 100, which is configured to fit into the drainage hole D of the frame B, is snapped into the drainage hole D to effect the firm attachment of the packaging piece 100 to the corner of the frame B. In one embodiment, the sides of the packaging piece 100 are symmetrical, and when the packaging piece 100 is oriented such that the frame interlocking structure 100i of the packaging piece 100 engages the drainage hole D, the frame interlocking structure 100j of the packaging piece 100, is configured to extend toward the surface of the glass component A of the photovoltaic module 101 without actually contacting the surface of the glass component A of the photovoltaic module 101. In particular, in one embodiment, the frame interlocking structure 100i is configured to be snap fitted into the drainage hole D in a first orientation and to extend toward the surface of the glass component A of the photovoltaic module 101 (without contacting the surface of the glass component A of the photovoltaic module 101) in a second orientation. And similarly, in one embodiment, the frame interlocking structure 100j is configured to extend toward the surface of the glass component A of the photovoltaic module 101 (without contacting the surface of the glass component A of the photovoltaic module 101) in the first orientation and to be snap fitted into the drainage hole D in the second orientation.

FIG. 1I shows a cross section of a portion of the photovoltaic module 101 and the packaging piece 100 through b-b shown in FIG. 1H when the packaging piece 100 is attached to the corner of the photovoltaic module 101. FIG. 1I also depicts, among other features of the packaging piece 100, frame interlocking structure 100i and frame interlocking structure 100j.

Referring to FIG. 1I, frame interlocking structure 100i is shown as extending through the drainage hole (D in FIG. 1G) of the frame B such that an interlocking of the packaging piece 100 and the frame B is effected. In particular, the frame interlocking structure 100i is configured to be snap fitted into the drainage hole such that a firm attachment of the packaging piece 100 to the corner of the frame B is effected. In one embodiment, when the frame interlocking structure 100i is snap fitted into the drainage hole, the frame interlocking structure 100j is positioned to extend from the inner surface of the second sidewall (100d in FIG. 1A) of the packaging piece 100 in a direction that is perpendicular to the inner surface of the second sidewall of the packaging piece 100. As shown in FIG. 1I, the frame interlocking structure 100j that extends from the inner surface of the second sidewall of the packaging piece 100 is configured such that it does not extend a distance that would result in contact with the surface of the glass component A. FIG. 1I shows that when the packaging piece 100 is attached to a corner of the photovoltaic module (101 in FIG. 1F), the frame interlocking structure 100i extends through the drainage hole of the frame B such that the top portion of the frame interlocking structure 100i is positioned above the drainage hole so as to engage portions of the flange that surround the periphery of the drainage hole.

FIG. 1J shows a stack of photovoltaic modules 101₁-101ₙ stacked using a non-alternating arrangement of modules. FIG. 1K shows how packaging pieces 100₁ and 100₂ are oriented when the photovoltaic modules to which they are attached, 101₁ and 101₂, are stacked using such a non-alternating arrangement of modules. As shown in FIG. 1K, the packaging piece 1001 includes packaging piece interlocking cavities 100q₁, 100r₁, 100sᵢ and 100t₁ into which the packaging piece interlocking structures 100k₂, 100l₂, 100m₂ and 100n₂ of the adjacent packaging piece 100₂ can be inserted when modules 101₁ and 101₂ are stacked using a non-alternating arrangement of modules (100m₂ and 100n₂ not visible from the perspective depicted in FIG. 1K).

FIGS. 1L and 1M show short side and long side perspectives of a stack of photovoltaic modules 101₁-101ₙ that uses an alternating arrangement of modules (alternating sunny side up and sunny side down arrangement of modules) according to one embodiment. FIG. 1L shows a short side perspective view of the stack of photovoltaic modules 101₁-101ₙ, packaging pieces 100ₐ-100ₙ, and pallet 111. In addition, FIG. 1L shows module glass components A₁-Aₙ, module frame components B₁-Bₙ, module backsides C₁-Cₙ and alternating current microinverters (hereinafter “ACMIs”) E₁-Eₙ (drainage holes D₁-Dₙ associated with the photovoltaic modules 101₁-101ₙ are not illustrated in FIG. 1L). FIG. 1M shows a long side perspective view of the stack of photovoltaic modules 101₁-101ₙ, packaging pieces 100₁-100ₙ and pallet 111. In addition, FIG. 1M shows module frame components B₁-Bₙ and ACMIs E₁-Eₙ.

Referring to FIG. 1L, the photovoltaic modules 101₁-101ₙ are stacked horizontally. In one embodiment, the glass components A₁-Aₙ of the photovoltaic modules 101₁-101ₙ are on the “sunny side” of the photovoltaic module. In one embodiment, the frame components B₁-Bₙ can be coupled to the glass components A₁-Aₙ but can extend in the direction of, and beyond, the backsheet of the photovoltaic module. In one embodiment, the ACMIs E₁-Eₙ that are associated with the photovoltaic modules 101₁-101ₙ can be located on the backsheet side of the photovoltaic modules and can be positioned near an end of such photovoltaic modules. In particular, the ACMIs E₁-Eₙ can be centered near an end of the photovoltaic modules 101₁-101ₙ with which they are associated. In one embodiment, for photovoltaic modules in the stack of photovoltaic modules 101₁-101ₙ that share a frame-to-frame interface, the orientation of the individual photovoltaic modules that share the interface is selected such that the ACMI of the sunny side up module and the ACMI of the sunny side down module are located near opposite ends. In one embodiment, because the height of an ACMI can be greater than the height of the frame of the photovoltaic module with which it is associated, the aforementioned orientation enables the ACMI to extend beyond the space circumscribed by the frame of the photovoltaic module with which it is associated into unoccupied space circumscribed by the frame of the photovoltaic module with which its photovoltaic module shares a frame-to-frame interface.

This is illustrated in FIG. 1M, which shows a long side perspective of a stack of the photovoltaic modules 101₁-101ₙ (shown in FIG. 1L) that uses an alternating sunny side up and sunny side down arrangement of modules according to one embodiment. Referring to FIG. 1M, the ACMI E₁ of the photovoltaic module 101₁ extends downward beyond the space circumscribed by the frame of the photovoltaic module 101₁ into the space circumscribed by the frame of the photovoltaic module 101₂. And the ACMI E₂ of the photovoltaic module 101₂ extends upward beyond the space circumscribed by the frame of the photovoltaic module 101₂ into the space circumscribed by the frame of the photovoltaic module 101₁.

FIG. IN is an exploded view of an alternating sunny side up and sunny side down arrangement of modules that shows relative positions of the modules (including ACMI) according to one embodiment. FIG. IN shows the manner in which the ACMI E₁ of module 101₁ extends downward beyond the space circumscribed by the frame of the module 101₁ and the manner in which ACMI E₂ of module 101₂ extends upward beyond the space circumscribed by the frame of the module 101₂ into the space circumscribed by the frame of module 101₁.

FIG. 1O shows how packaging pieces 100₁ and 100₂ are oriented when the modules to which they are attached, 101₁ and 101₂, are stacked using an alternating arrangement of modules. As shown in FIG. 1O, the packaging piece 100₁ includes packaging piece interlocking cavities 100q₁, 100r₁, 100s₁ and 100t₁ (not visible) into which the interlocking structures 100k₂, 100l₂, 100m₂ (not visible) and 100n₂ (not visible) of the adjacent packaging piece 100₂ can be inserted when modules 101₁ and 101₂ are stacked using an alternating arrangement of modules. FIG. 10 illustrates that when modules are stacked using an alternating arrangement of modules the orientation of the packaging pieces can be maintained even though certain modules are reoriented or flipped to realize the alternating arrangement of modules.

Referring again to FIG. 1A, in one embodiment, the first L-angle portion 100a of the packaging piece 100 extends a distance of between 79.5 and 80.5 mm from second backside surface 100p of the packaging piece 100. In other embodiments, the first L-angle portion 100a can extend other distances from the second backside surface 100p of the packaging piece 100. In one embodiment, the second L-angle portion 100b of the packaging piece 100 extends a distance of between 79.5 and 80.5 mm from a first backside surface 100o of the packaging piece 100. In other embodiments, the second L-angle portion 100b can extend other distances from the first backside surface 1000 of the packaging piece 100. In one embodiment, the first orthogonally oriented portion 100e of the first sidewall structure 100c extends a distance of between 101.5 and 102.5 mm from the second backside surface 100p of the packaging piece 100. In other embodiments, the first orthogonally oriented portion 100e of first sidewall structure 100c can extend other distances form the second backside surface 100p of the packaging piece 100. In one embodiment, the second orthogonally oriented portion 100f of first sidewall structure 100c extends a distance of between 101.5 and 102.5 mm from the first backside surface 100o of the packaging piece 100. In other embodiments, the second orthogonally oriented portion 100f of first sidewall structure 100c can extend other distances from the first backside surface 100o of the packaging piece 100.

In one embodiment, the first orthogonally oriented portion 100g of the second sidewall structure 100d extends a distance of between 101.5 and 102.5 mm from the second backside surface 100p of the packaging piece 100. In other embodiments, the first orthogonally oriented portion 100g of second sidewall structure 100d can extend other distances form the second backside surface 100p of the packaging piece 100. In one embodiment, the second orthogonally oriented portion 100h of second sidewall structure 100d extends a distance of between 101.5 and 102.5 mm from the first backside surface 100o of the packaging piece 100. In other embodiments, the second orthogonally oriented portion 100h of second sidewall structure 100d can extend other distances from the first backside surface 100o of the packaging piece 100.

In one embodiment, the first orthogonally oriented portion 100e of the first sidewall structure 100c extends a distance of between 29.85 and 29.15 mm from the first backside surface 100o of the packaging piece 100. In other embodiments, the first orthogonally oriented portion 100e of the first sidewall structure 100c can extend other distances form the first backside surface 100o of the packaging piece 100. In one embodiment, the second orthogonally oriented portion 100f of the first sidewall structure 100c extends a distance of between 29.85 and 29.15 mm from the second backside surface 100p of the packaging piece 100. In other embodiments, the second orthogonally oriented portion 100f of the first sidewall structure 100c can extend other distances form the second backside surface 100p of the packaging piece 100.

In one embodiment, the first orthogonally oriented portion 100g of second sidewall structure 100d extends a distance of between 29.85 and 29.15 mm from the first backside surface 100o of the packaging piece 100. In other embodiments, the first orthogonally oriented portion 100g of second sidewall structure 100d can extend other distances form the first backside surface 100o of the packaging piece 100. In one embodiment, the second orthogonally oriented portion 100h of second sidewall structure 100d extends a distance of between 29.85 and 29.15 mm from the second backside surface 100p of the packaging piece 100. In other embodiments, the second orthogonally oriented portion 100h of second sidewall structure 100d can extend other distances form the second backside surface 100p of the packaging piece 100.

Referring again to FIG. 1A, in one embodiment, the first module frame interlocking structure 100i can extend perpendicularly a distance of between 1.55 and 1.64 mm from the inside surface of the first sidewall structure 100c. In other embodiments, the first module frame interlocking structure 100i can extend other distances from the inside surface of the first sidewall structure 100c. In one embodiment, the second module frame interlocking structure 100j can extend perpendicularly a distance of between 1.55 and 1.64 mm from the inside surface of the second sidewall structure 100d. In other embodiments, the second module frame interlocking structure 100j can extend other distances from the inside surface of the second sidewall structure 100d. In one embodiment, the first module frame interlocking structure 100i can have a top portion formed to extend laterally beyond the perimeter of the frame drainage hole to facilitate the interlock of the packaging piece 100 to the module frame. In one embodiment, the second module frame interlocking structure 100j can have a top portion formed to extend laterally beyond the perimeter of the frame drainage hole to facilitate the interlock of the packaging piece 100 to the module frame. In other embodiments, the first module frame interlocking structure 100i and the second module frame interlocking structure 100j can have a top portion that has any shape or geometry that can engage the drainage hole in a manner that causes the interlock of the packaging piece 100 to the module frame. In one embodiment, the packaging piece interlocking structures 100k, 100l, 100m and 100n can extend a distance of between 14.5 mm and 15.5 mm perpendicularly from the outside surface of the second sidewall structure 100d (their base) to their top surfaces. In other embodiments, the packaging piece interlocking structures 100k, 100l, 100mand 100n can extend other distances from the outside surface of the second sidewall structure 100d to their top surfaces. In one embodiment, the packaging piece interlocking structures 100k, 100l, 100m and 100n can have a base with dimensions 18 mm×10 mm. In other embodiments, the packaging piece interlocking structures 100k, 100l, 100m and 100n can have a base with other dimensions. In one embodiment, the packaging piece interlocking structures 100k, 100l, 100m and 100n can include a beveled top portion with a flat and rectangular top surface with dimensions 12×4 mm. In other embodiments, the packaging piece interlocking structures 100k, 100l, 100m and 100n can include a top portion with other dimensions. In one embodiment, the packaging piece interlocking cavities 100q, 100r, 100s and 100t can have an opening with dimensions 19×11 mm and can be configured to accommodate packaging piece interlocking structures of a packaging piece attached to an adjacent photovoltaic module. In other embodiments, the packaging piece interlocking cavities 100q, 100r, 100s and 100t can have other dimensions.

### Operation

In operation, packaging pieces 100 enable photovoltaic modules to be packed using two stacking configurations: (1) with non-alternating orientations, or (2) with alternating orientations (e.g., back-to-back and face-to-face orientations). In one embodiment, when photovoltaic modules 101₁-101ₙ are stacked with alternating orientations (e.g., back to back and face to face orientations as described herein) even where the frame height of the photovoltaic modules has been reduced to increase shipping density, space is available for the ACMI E₁-Eₙ of each photovoltaic module to extend beyond the space circumscribed by the frame of its own photovoltaic module into the space circumscribed by the frame of the photovoltaic module with which its photovoltaic module has a frame-to-frame interface.

In one embodiment, packaging pieces can make the packaging of partial pallet packages more convenient and can help protect modules from damage during transport. For example, for vertically packed packages, packaging pieces can make the packaging of partial pallet packages convenient by eliminating the need to apply rigid support structures to modules before they are turned upright in a vertically oriented direction. For horizontal partial pallet packages, packaging is made more convenient as multiple modules of a partial pallet package can be simultaneously aligned to provide a neat and agreeable package appearance.

In one embodiment, packaging pieces protect horizontal partial pallet packages, by transferring shocks and vibrations encountered during their transport to their pallets and away from their modules (to prevent micro-cracks). For vertical partial pallet packages, because packaging pieces limit a module's movement within the space between their sidewalls, frame scratches between adjacent modules are avoided. Furthermore, the interlocking structures, hold the interlocked modules together, such that they are prevented from falling apart, even when straps loosen during transport (which eliminates a critical safety concern).

### Method of Forming Packaging Piece

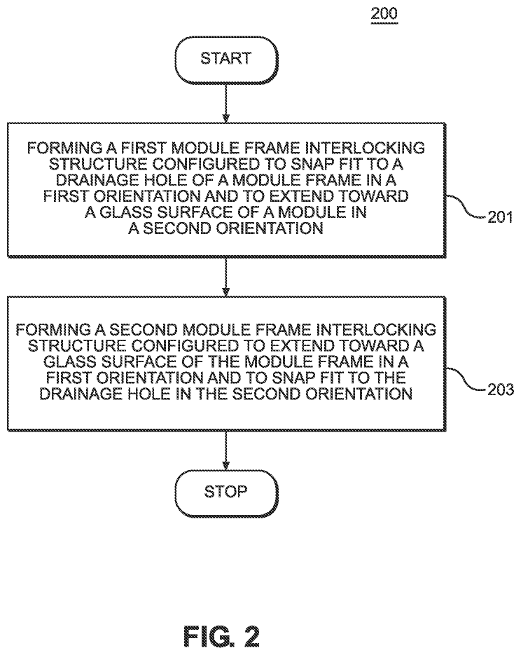

FIG. 2 shows a flowchart of a method of forming a packaging piece such as a packaging piece (100 in FIG. 1A) according to one embodiment. It should be noted that, in one embodiment, the order of execution of the blocks of the flowchart of FIG. 2 can be changed. Referring to FIG. 2, the method includes at 201, forming a first side that includes forming a first module frame interlocking structure configured to snap fit to a drainage hole of a module frame in a first orientation and to extend toward a glass surface of a module in a second orientation; and at 203, forming a second side that includes forming a second module frame interlocking structure configured to extend toward the glass surface of the module in the first orientation and to snap fit to the drainage hole of the module frame in the second orientation.

In one embodiment, the first orientation and the second orientation are radially separated by 180 degrees. In one embodiment, the first frame interlocking structure and the second frame interlocking structure are symmetrically located on the packaging piece. In one embodiment, the packaging piece includes a first sidewall and a second sidewall. In one embodiment, the first sidewall and the second sidewall include orthogonally oriented portions. In one embodiment, the first frame interlocking structure is located between orthogonally oriented portions of the first sidewall. In one embodiment, the second frame interlocking structure is located between orthogonally oriented portions of the second sidewall. In one embodiment, the packaging piece includes a plurality of packaging piece interlocking structures. In one embodiment, the packaging piece includes a plurality of packaging piece interlocking cavities. In one embodiment, the plurality of packaging piece interlocking structures and the plurality of packaging piece interlocking cavities are located on first and second sides of the packaging piece.

Although specific embodiments have been described above, these embodiments are not intended to limit the scope of the present disclosure, even where only a single embodiment is described with respect to a particular feature. Examples of features provided in the disclosure are intended to be illustrative rather than restrictive unless stated otherwise. The above description is intended to cover such alternatives, modifications, and equivalents as would be apparent to a person skilled in the art having the benefit of the present disclosure.

The scope of the present disclosure includes any feature or combination of features disclosed herein (either explicitly or implicitly), or any generalization thereof, whether or not it mitigates any or all of the problems addressed herein. Thus, the various features of the different embodiments may be variously combined, with some features included, and others excluded to suit a variety of different applications. Accordingly, new claims may be formulated during prosecution of the present application (or an application claiming priority thereto) to any such combination of features. In particular, with reference to the appended claims, features from dependent claims may be combined with those of the independent claims and features from respective independent claims may be combined in any appropriate manner and not merely in the specific combinations enumerated in the appended claims.

What is claimed is:

1. A packaging piece, comprising:
a first side that includes:
a first module frame interlocking structure configured to snap fit to a drainage hole of a module frame in a first orientation and to extend toward a glass surface of a module in a second orientation; and
a second side that includes:
a second module frame interlocking structure configured to extend toward the glass surface of the module in the first orientation and to snap fit to the drainage hole of the module frame in the second orientation.

2. The packaging piece of claim 1, wherein the first orientation and the second orientation are radially separated by 180 degrees.

3. The packaging piece of claim 1, wherein the first frame interlocking structure and the second frame interlocking structure are symmetrically located on the packaging piece.

4. The packaging piece of claim 1, further comprising a first sidewall and a second sidewall.

5. The packaging piece of claim 4, wherein the first sidewall and the second sidewall include orthogonally oriented portions.

6. The packaging piece of claim 5, wherein the first frame interlocking structure is located between orthogonally oriented portions of the first sidewall.

7. The packaging piece of claim 5, wherein the second frame interlocking structure is located between orthogonally oriented portions of the second sidewall.

8. The packaging piece of claim 1, further comprising:
a plurality of packaging piece interlocking structures; and
a plurality of packaging piece interlocking cavities, wherein the plurality of packaging piece interlocking structures and the plurality of packaging piece interlocking cavities are located on first and second sides of the packaging piece.

9. A package of modules, comprising:
a plurality of modules; and
module packaging pieces attached to the plurality of modules, wherein the module packaging pieces comprise:
a first side that includes:
a first module frame interlocking structure configured to snap fit to a drainage hole of a module frame in a first orientation and to extend toward a glass surface of a module in a second orientation; and
a second side that includes:
a second module frame interlocking structure configured to extend toward the glass surface of the module in the first orientation and to snap fit to the drainage hole of the module frame in the second orientation.

10. The package of modules of claim 9, wherein the first orientation and the second orientation are radially separated by 180 degrees.

11. The package of modules of claim 9, wherein the first frame interlocking structure and the second frame interlocking structure are symmetrically located on the module packaging pieces.

12. The package of modules of claim 9, further comprising a first sidewall and a second sidewall.

13. The package of modules of claim 12, wherein the first sidewall and the second sidewall include orthogonally oriented portions.

14. The package of modules of claim 13, wherein the first frame interlocking structure is located between orthogonally oriented portions of the first sidewall.

15. The package of modules of claim 13, wherein the second frame interlocking structure is located between orthogonally oriented portions of the second sidewall.

16. The package of modules claim 9, further comprising:
a plurality of packaging piece interlocking structures; and
a plurality of packaging piece interlocking cavities, wherein the plurality of packaging piece interlocking structures and the plurality of packaging piece interlocking cavities are located on first and second sides of the module packaging pieces.

17. A method of forming a packaging piece, comprising:
forming a first side that includes forming a first module frame interlocking structure configured to snap fit to a drainage hole of a module frame in a first orientation and to extend toward a glass surface of a module in a second orientation; and
forming a second side that includes forming a second module frame interlocking structure configured to extend toward the glass surface of the module in the first orientation and to snap fit to the drainage hole of the module frame in the second orientation.

18. The method of forming a packaging piece of claim 17, wherein the first orientation and the second orientation are radially separated by 180 degrees.

19. The method of forming a packaging piece of claim 17, wherein the first frame interlocking structure and the second frame interlocking structure are symmetrically located on the packaging piece.

20. The method of forming a packaging piece of claim 17, further comprising forming a first sidewall and a second sidewall.
